(19) United States
(12) Patent Application Publication
(10) Pub. No.: US 2022/0023809 A1
(43) Pub. Date: Jan. 27, 2022

(54) INDUCED CAVITATION MIXING APPARATUS

(71) Applicant: Vitalis Extraction Technology Inc., Kelowna (CA)

(72) Inventor: James Anthony SEABROOK, West Kelowna (CA)

(21) Appl. No.: 17/311,712

(22) PCT Filed: Jan. 2, 2020
(86) PCT No.: PCT/CA2020/050001

§ 371 Date: Jun. 8, 2021

Related U.S. Application Data
(60) Provisional application No. 62/788,038, filed on Jan. 3, 2019.

(51) Int. Cl. B01F 11/02; B01D 11/04; B01F 13/02; B01F 15/06

(52) U.S. Cl. CPC B01F 11/0258; B01D 11/0423; B01F 2015/061; B01F 13/0222; B01F 15/065; B01D 11/0403

(57) ABSTRACT

A cavitation mixing apparatus is provided for performing separations from solid material using subcritical liquid CO₂. A cavitation inducing device inside a cavitation mixing vessel is held in place with a cavitation mixer mount comprising at least one fluid channel for equalizing gaseous pressure of CO₂ around the cavitation inducing device. Also described is method of separating oils from a crude plant oil mixture by injecting crude plant oil into a pressurized mixing vessel comprising liquid carbon dioxide and mixing the crude oil with the liquid carbon dioxide under pressure using powered induced cavitation, the cavitation mixing vessel comprising an encapsulated cavitation inducing device.

### CROSS-REFERENCE TO RELATED APPLICATIONS

This application claims priority to United States provisional patent application U.S. 62/788,038 filed 3 Jan. 2019, the contents of which are hereby incorporated by reference herein in its entirety.

### FIELD OF THE INVENTION

The present invention pertains to an induced cavitation mixing and separation apparatus and system for mixing and breaking up waxes and solid masses in heterogeneous mixtures in a pressure controlled environment.

### BACKGROUND

The process of dewaxing, or removing fats and waxes from crude oil plant extracts, is also called winterization. Dewaxing or winterization traditionally involves using a combination of organic solvents and controlled cooling to facilitate fat and wax separation from material soluble in the liquid solvent. In traditional winterization, ethanol or another organic solvent requires distillation to obtain the desirable soluble oil. The distillation and removal of organic solvent from the desired oil can be a complex and lengthy process depending on the purity level required.

Carbon dioxide (CO₂) fluid extraction, separation, and purification, is becoming an important commercial and industrial process due to the usability of CO₂ in chemical separation in addition to its low toxicity, non-flammability, low cost, and low environmental impact. The relatively low temperature of the process and the stability of CO₂ also allows many compounds to be extracted with little damage or denaturing. In addition, the solubility of many extracted compounds in CO₂ varies with pressure, permitting selective separations. Carbon dioxide behaves as a gas in air at standard temperature and pressure (STP), and its physical state can be tuned by controlling temperature and pressure in a closed system or closed environment. CO₂ extraction can be used, for example, for analytical purposes, decaffeination or component removal from a plant material, in winterization to separate fats and waxes from plant extracts, and for separating and collecting desired products from plant products such as terpenes and essential oils. Compared to other forms of extraction and separation, the use of carbon dioxide is also advantageous because the CO₂ solvent can be easily separated from the extract by evaporation. By using liquid CO₂ as the solvent in winterization, the solvent separation process is simplified, as CO₂ evaporates at a much lower temperature than the compounds of interest and therefore can be easily evaporated by raising the temperature or lowering the pressure of the mixture.

In closed systems and in pressure controlled environments where CO₂ is held at conditions in or around the critical point or saturation line, such as in a subcritical extraction, both liquid and vapour CO₂ can exist simultaneously in the system. In these types of pressurized closed systems, integrated mechanical mixing can be challenging due to the extreme and sealed conditions inside the vessel and system. In one example of a system for collecting particles using high pressure supercritical fluid processing, U.S. Pat. No. 9,925,512 to Johnson et al. describes a filtration system for processing particles suspended in supercritical fluid, optionally using a vibrating member or mesh.

Powered ultrasonic mixers are used to apply sound energy in ultrasonic frequencies (>20 kHz) to agitate particles in a sample for various purposes such as the extraction of multiple compounds from plants, microalgae and seaweeds, and to break up larger aggregates or emulsify fluids. Sonication can be used, for example, for the production of nanoparticles, such as nano-emulsions, nanocrystals, liposomes and wax emulsions, as well as for treating wastewater, degassing, extraction of polysaccharides and oil from biological materials, extraction of anthocyanins and antioxidants, petroleum processing such as in crude oil desulfurization and cracking, production of biofuels, cell disruption, polymer and epoxy processing, adhesive thinning, and many other processes. Sonication has also been used widely in various industrial processes such as in the production of pharmaceuticals, cosmetics, ink, paint, coating, nanocomposites, pesticides, fuels, and food, as well as in water treatment, wood treatment, metalworking, and many other industries. Ultrasonic mixing can also potentially lower processing costs in industrial processes by speeding up mixing and chemical processes.

In practice, ultrasonic waves travel as a successive series of compressions and rarefactions along the direction of wave propagation through the liquid medium. Ultrasonic mixers or sonicators produce and propagate these sound waves through a solvent or fluid medium. Liquids can be treated by creating ultrasonic waves, such as with an elongate ultrasonic horn moving longitudinally in the mixing vessel to create longitudinal mechanical waves inducing pressure variations which generates lower pressure cavitation bubbles as they transmit through a liquid medium. Other devices are also known that create cavitation bubbles by inducing pressure variations in a liquid, such as various types of shear mixers. During ultrasonic mixing, a tiny cavity is created and is filled with vapor from the liquid solvent when the attraction forces between the liquid molecules became weaker and less than the negative pressure of the cyclic rarefaction. Cavitation occurs when the pressure in a location decreases below the vapour pressure of the liquid solvent, forming an acoustic cavitation bubble of gaseous solvent. Once the local pressure returns to the vapour pressure of the liquid solvent, the cavitation bubble collapses back to liquid form. The cavitation or collapse of these low pressure microbubbles transform applied pressure into mechanical energy upon collapse by creating pressure shocks from bubble collapses, sending out local shock waves, which can cause breakup of local particulate and emulsification.

In high pressure closed vessel separations, one challenge in using cavitation technology is that pressures on the cavitation inducing device inside the vessel in the use of high frequency vibrations in combination with high vessel pressure can vibrate the vessel and cause undue stress in the system. In one example, U.S. Pat. No. 7,762,715 to Gordon et al. describes a device for processing petroleum crude oil in a flow-through hydrodynamic cavitation apparatus with channels to create cavitation by way of directing fluid pressure and fluid flow. By forcing fluids into the flow-through hydrodynamic cavitation apparatus, chemical reactions and/or changes physical properties of the fluid are induced to change the physical properties of the crude oil.

In high pressure systems such as those required to maintain CO₂ in a liquid state, the solvent needs to be maintained at relatively high pressures, which creates a challenge for powered ultrasonic and cavitation inducing mixers where the transducer or motor is located outside of the mixing vessel. There remains a need for an induced cavitation mixing apparatus capable of operating at subcritical fluid solvent conditions.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide an induced cavitation mixing apparatus for mixing and breaking up waxes and solid masses in heterogeneous mixtures in a pressure controlled environment. Also provided is a device, system and method for mixing of components of a pressure controlled closed environment.

In an aspect there is provided a cavitation mixing apparatus comprising: a cavitation mixing vessel comprising a material inlet and a discharge outlet, the cavitation mixing vessel capable of containing pressurized liquid CO₂; a cavitation inducing device mounted inside the cavitation mixing vessel; an electrical connection for connecting the cavitation inducing device to a power supply through the cavitation mixing vessel; and a cavitation mixer mount for mounting the cavitation inducing device inside the cavitation mixing vessel, the cavitation mixer mount comprising at least one fluid channel for equalizing pressure of CO₂ around the cavitation mixer inside the cavitation mixing vessel.

In one embodiment of the apparatus, the cavitation inducing device is an ultrasonic mixer.

In another embodiment of the apparatus, the ultrasonic mixer has a frequency of at least 20 KHz.

In another embodiment of the apparatus, the ultrasonic mixer produces an ultrasonic vibration at a frequency of between 20 KHz to 1.0 MHz.

In another embodiment of the apparatus, the cavitation inducing device is a high shear cavitation mixer.

In another embodiment, the apparatus further comprises an injection tube to direct crude oil proximate the cavitation inducing device.

In another embodiment of the apparatus, the cavitation mixer mount comprises a plurality of fluid channels.

In another aspect there is provided a cavitation dewaxing system comprising: a carbon dioxide reservoir for containing liquid carbon dioxide; a cavitation mixing vessel comprising an encapsulated cavitation inducing device; a separation vessel; and an evaporation vessel.

In one embodiment of the system, the cavitation inducing device is an ultrasonic mixer.

In another embodiment of the system, the cavitation inducing device is a high shear cavitation mixer.

In another embodiment, the system further comprises a carbon dioxide condenser.

In another embodiment of the system, the separation vessel comprises a filter.

In another embodiment, the system is a passive circulation system.

In another aspect there is provided a method of separating oils from a crude plant oil mixture, the method comprising: injecting crude plant oil into a mixing vessel comprising pressurized liquid carbon dioxide; and mixing the crude oil with the liquid carbon dioxide under pressure using by powered induced cavitation, the cavitation mixing vessel comprising an encapsulated cavitation inducing device.

In one embodiment of the method, the induced cavitation is provided by an ultrasonic mixer.

In another embodiment of the method, the induced cavitation is provided by a high shear mixer.

In another embodiment of the method, the pressure of liquid carbon dioxide in the mixing vessel is 80 to 15,000 psi.

In another embodiment of the method, the method is in a batch, semi-continuous, or continuous industrial process.

In another embodiment, the method further comprises filtering the crude oil and liquid carbon dioxide mixture, and evaporating off the carbon dioxide to isolate a purified plant oil.

### BRIEF DESCRIPTION OF THE FIGURES

For a better understanding of the present invention, as well as other aspects and further features thereof, reference is made to the following description which is to be used in conjunction with the accompanying drawings, where:

FIG. 1 is a front view of an induced cavitation dewaxing assembly;

FIG. 2 is a perspective view of an induced cavitation dewaxing assembly;

FIG. 3A is phase diagram of carbon dioxide;

FIG. 3B is a graph of density as a function of temperature of isobaric carbon dioxide at 500 psi;

FIG. 4A is a side view of a cavitation mixing vessel;

FIG. 4B is a perspective view of a cavitation mixing vessel;

FIG. 5 is a cross-sectional view of a mixing vessel with an induced cavitation mixing apparatus;

FIG. 6 is close-up cross sectional view of an induced cavitation mixer inside a cavitation mixing vessel;

FIG. 7A is a top perspective view of an induced cavitation mixer mount;

FIG. 7B is a top view of an embodiment of an induced cavitation mixer mount;

FIG. 7C is a top view of an embodiment of an induced cavitation mixer mount;

FIG. 8A is a side cross-sectional view of an induced cavitation mixer mount through plane A-A in FIG. 7B or 7C;

FIG. 8B is a top view of a high pressure electrical pass through fitting for a mixing vessel with an induced cavitation mixer;

FIG. 9 is cross-sectional view of a cavitation mixing vessel with an induced cavitation high shear cavitation mixer;

FIG. 10A is a front perspective view of a separation vessel;

FIG. 10B is a cross-sectional view of a separation vessel;

FIG. 11A is a perspective view of an evaporation vessel;

FIG. 11B is a cross-sectional view of an evaporation vessel; and

FIG. 12 is a system diagram of a cavitation dewaxing assembly.

### DETAILED DESCRIPTION OF THE INVENTION

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or element(s) as appropriate.

As used herein, the term “closed system” refers to an enclosed environment which limits material flow with the environment and where temperature and pressure are controlled. In a closed system, pressure is maintained in a controlled environment by limiting and controlling material and solvent influx and outflow and keeping the system largely closed from the external environment. In application, in systems that use CO₂ as a solvent, this means maintaining the system above a pressure that enables stabilization of liquid CO₂.

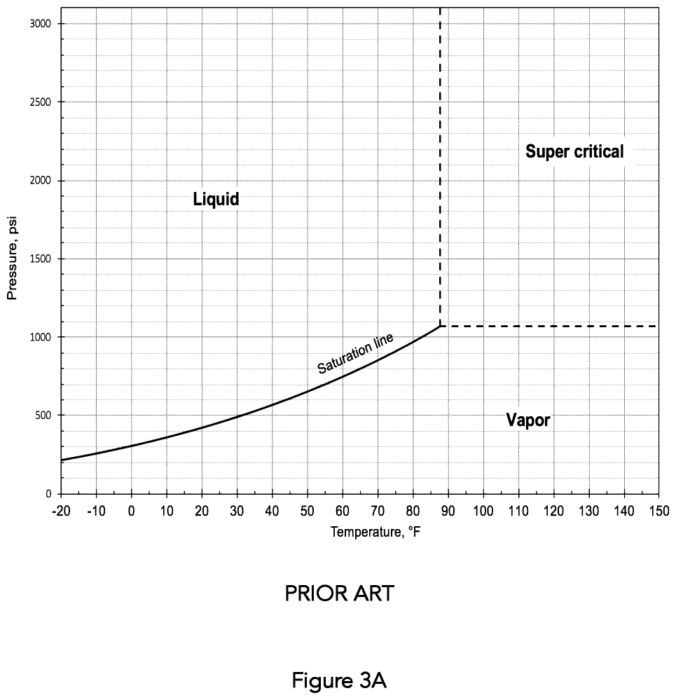

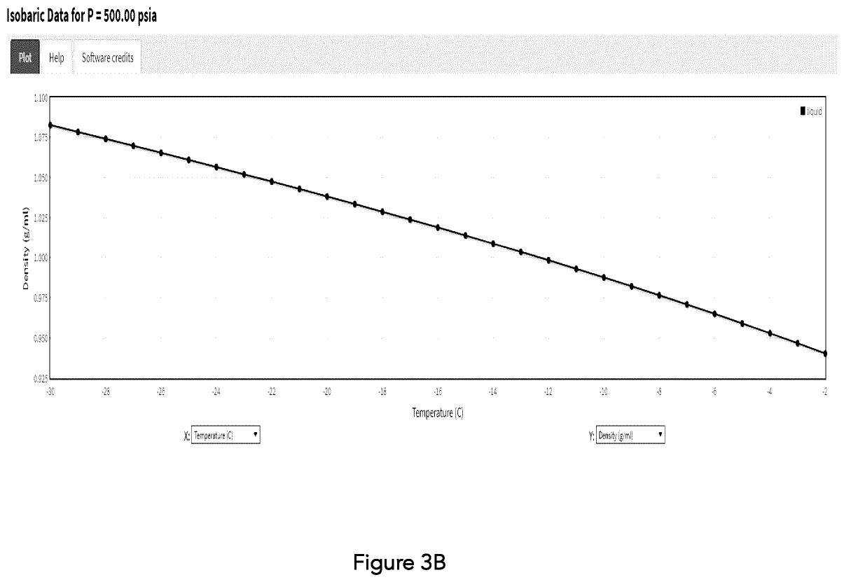

As used herein, the term “subcritical” refers to a physical state of a fluid wherein the fluid can exists as gas or vapour, liquid, or combination of both vapour and liquid. Subcritical fluids are fluids which are compressed below their critical temperatures, yet kept in the liquid state and used above their boiling points with the use of pressure. Subcritical fluid states vary along a range of temperatures and pressures and are unique to each fluid, which includes solvents, liquids, and the same with dissolved and/or emulsified materials therein. Subcritical conditions for CO₂ are shown in FIG. 3A as the saturation line. Generally subcritical conditions exist below about 7.39 MPa (1,071 psi) and below about 31.2 degree centigrade.

As used herein, the term “closed,” as it refers to a system or apparatus, refers to one or more connected vessels that are sealed to the environment. Such systems can optionally be pressurized and are sufficiently sealed such that they can retain an internal pressure, or can contain a solvent from evaporation or leak outside of the system. Closed systems are particularly useful for maintaining increased pressures with pressurized solvents.

As used herein, the term “induced cavitation” refers to cavitation applied to a fluid where the cavitation is created by a powered device. This is in contrast to passive cavitation which can be caused by structural features as a result of fluid flow, such as, for example, barriers or obstacles such as fins, filters, meshes, and the like.

Herein is described a cavitation mixing system and induced cavitation mixing apparatus capable of operating at subcritical solvent conditions in a pressure controlled environment. The present system and apparatus can be used for winterization and dewaxing of plant materials, as well as other industrial and chemical processes that benefit from cavitation mixing in a closed environment, particularly those which operate in subcritical solvent conditions in closed systems. By inputting cavitation energy into a closed, induced cavitation mixing vessel, solvent and solute mixtures can benefit from cavitation mixing in a pressurizable closed environment in batch, semi-continuous, or continuous industrial processes. The presently described induced cavitation mixer or mixing apparatus is operable at subcritical conditions and can be used in closed systems and pressure controlled environments.

Cavitation involves the phenomenon of vapor bubble formation in the solvent fluid experiencing reduced pressure, which is followed by violent bubble collapse. The phenomenon is named cavitation because cavities form when the fluid pressure has been reduced to the vapor pressure of its constituent(s), in this case liquid carbon dioxide. The vapor bubbles expand as they move and suddenly collapse. The violent collapse causes sudden, localized increases in temperature and pressure, as well as tiny but powerful micro jets which hold an enormous amount of kinetic energy and cause physical damage to circulating crude oil and wax particulate, breaking apart the particulate. Particulate disruption caused by the cavitation improves access of the solvent to desirable oils inside the wax particulate and increases the yield from extractive and separative processes.

The present apparatus and separation vessel with integrated induced cavitation mixing device are compatible with the high pressures required for subcritical fluid dewaxing and separation, as well as other processes that benefit from induced cavitation in closed system mixing in a pressure controlled environment. A commonly used subcritical solvent is liquid carbon dioxide, however it is understood that other solvents may be used, as well as combinations of solvents with and without CO₂. Carbon dioxide will be referred to herein as an example solvent, however it is understood that the presently described devices, apparatus and methods can be used with any subcritical fluid, or any solvent or industrial mixing process done in a closed or pressure-controlled environment. The present apparatus can also be used in standard or atmospheric solvent conditions and under other temperatures and pressures where solvent is retained inside a closed vessel system or in a closed process.

The critical point of CO₂ is easily accessible as it has a critical temperature of 31° C. and critical pressure 73.9 bar (72.9 atm). Above the critical point CO₂ behaves as a supercritical fluid above its critical temperature (304.25 K, 31.10° C., 87.98° F.) and critical pressure (72.9 atm, 7.39 MPa, 1,071 psi, 73.9 bar). Subcritical solvents are of interest when extracting yields with increased volumes of terpenoids, flavonoids, and other such volatile plant materials at least because subcritical carbon dioxide runs at milder separation parameters than other solvents, targeting those volatile compounds. Through only modest changes in the temperature and pressure, the physical properties of CO₂ can be manipulated. CO₂ can be a stable liquid from about 80 psi and roughly −57° C. which would prove a very low pressure extraction with very low solubility, however the pressure of CO₂ can be increased so long as the process stays below 31° C., which is the critical temperature limit. FIG. 3A is phase diagram of carbon dioxide showing the phase of CO₂ at various temperatures and pressures. A wide range of extractant selectability is available when working with pressures lower than 3,000 psi as CO₂ has solvency power from 300 psi and up. Moreover, by changing separation pressure and temperature, the solubility and selectivity of the CO₂ solvent for species of interest can be changed to optimize the separation to exclude undesired compounds. At subcritical parameters it is also possible to remove extractants that are thermolabile, resulting in more aromatic extracts. Extracts obtained from CO₂ solvent extraction most closely resemble the natural starting material as they have little to no extractant contaminants, which is advantageous for pure and essential oil separation.

The solvent power of subcritical fluids is dependent on the temperature utilized and temperature helps to increase solvency. In contrast, pressure is used to help retain the liquid state of the fluid. Subcritical separations at low temperature and low pressure take more time than superfluid separations, but they can be used effectively to retain the essential oils terpenes and other sensitive chemicals within the plant. Subcritical CO₂ separation is often preferred because the milder conditions result in production of a lighter colored extract, fewer waxes, and resins, and retention of more volatile oils. Subcritical separation can also be used effectively to scrub the extractant matrix of any valuable compounds and achieve a full-spectrum extraction. In any closed system with controlled pressure, embedded mixing systems can improve extraction efficiency as well as product yield and purity by improving in situ mixing.

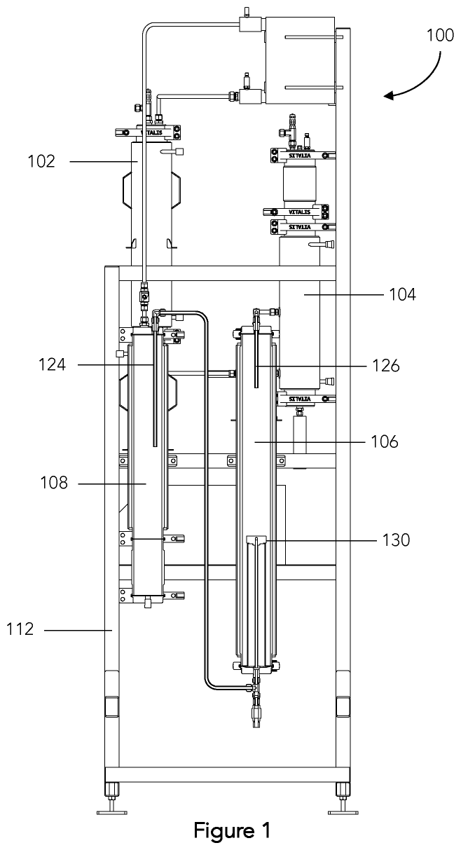

FIG. 1 is a front view of a pressurized cavitation dewaxing assembly. Cavitation dewaxing assembly 100 is comprised of four main vessels: a fluid reservoir 102; a cavitation mixing vessel 104; a separation/filter vessel 106; and an evaporation vessel 108. An induced cavitation device integrated inside in the cavitation mixing vessel 104 assists in mixing, emulsification, and/or solubilization of desirable oils from the waxy starting material. The cavitation dewaxing process is thermodynamically driven by the rate of evaporation of CO₂ and the circulation of subcritical fluid in the closed system. The fluid reservoir 102 provides a source of subcritical fluid to the assembly for controlling the amounts of circulating fluid as well as for controlling the pressure inside the assembly. Preferably, all vessels are stainless steel, use food grade materials, and can be disassembled for cleaning. Support structure 112 provides a stable support for the cavitation dewaxing assembly components. In an embodiment, one or more of the subcritical fluid reservoir 102, cavitation mixing vessel 104, separation/filter vessel 106, and evaporation vessel 108 is made of high strength steel formed into a collared barrel coated with a uniform covering of nickel or chromium or lined with a thin wall stainless steel insert. Separation/filter vessel 106 can also comprise one or more filter or filter devices.

The CO₂ solvent is supplied to the cavitation dewaxing assembly from fluid reservoir 102 to cavitation mixing vessel 104, optionally with the use of a fluid pump. The assembly can also be set up as a passive circulation system using only fluid flow through temperature control, and the optional addition of a pump can be used with either liquid (cooling and pumping) or vapor recovery (compressing and cooling), and could be added in different positions on the process flow. The fluid reservoir 102 holds the fluid solvent at a temperature and pressure to maintain the subcritical fluid properties of the solvent. Preferably the subcritical fluid is saturated liquid CO₂. The CO₂ reservoir can be further chilled via a refrigerated jacket to maintain CO₂ in a liquid phase. The assembly can further comprise a working fluid accumulator which can also be used to store liquid/gas subcritical working fluid. Working fluid is the general term of circulating fluid which is being used as a solvent in the extraction or separation process. In the present system the preferred working fluid is CO₂, optionally mixed with a co-solvent which stay in a liquid phase through the process. Some optional co-solvents include ethanol, methanol, hexane, heptane, propane, butane, and combinations thereof. Co-solvents may be used in ratios from 0 parts to 100:1 (co-solvent:input material) with a total solvent ratio from 1:1 to 100:1 (solvent solution:oils). Multiple injection nozzles may also be provided in the system for one or more additional oils and/or co-solvent injection into the system. The flow rate of CO₂ through the system and control of the flow rate can be passive by controlling the rate of evaporation, or active by pumping such as by controlling the flow of liquid inlet, or both. A high pressure multi-phase pump can also handle subcritical fluid solvents by enabling both the compression of gasses and/or the pumping of a fluid. Any pump known to the skilled person useful in subcritical fluid systems may be used, such as, for example, a liquid pump optionally in combination with one or more suitable compressor. An optional cross flow heat exchanger can also be used to control the temperature of CO₂ as required. From the fluid reservoir 102, CO₂ is provided to cavitation mixing vessel 104 where temperature and pressure conditions are adjusted to the desired conditions to maintain a balance of liquid and gas CO₂ in the vessel. Following emulsification the solution travels into the separation/filter vessel 106 where the density of CO₂ can be controlled by adjusting the temperature to promote density separation of compounds. For example in isobaric condition of 500 psi CO₂ has a density from 1.08 g/ml @−30C to 0.94 g/ml @−2C, as shown in FIG. 3B. The separation vessel should be sized (or run in parallel) so that the process velocity does not carry the lighter compounds down. Molecules or groups of molecules can be concentrated in this fashion by setting a density to separate heavy molecules (heavy bottom fraction) from lighter compounds which will tend to ‘float’ in the column (light top fraction) by adjusting the temperature of the CO₂. In a continuous flow system the separation vessel could have a discharge from the top also for collection of the lighter top fraction, and the existing bottom filter section for collection of heavy fraction. The system can also comprise any combination of multiple vessels (separation/filter vessels) operating in parallel, or multiple mixing vessels operating in series with different frequencies or the same or different mixing devices in each vessel as needed.

The separation/filter vessel 106 is preferably located below the cavitation mixing vessel 104 such that the separation/filter vessel 106 can be gravity-assisted to fill completely with the mixed CO₂/extract mixture from the cavitation mixing vessel 104. The separation/filter vessel 106 can also be cooled by a refrigerated jacket. In the assembly shown, the oil/extract mixture is gravity fed into the top of the separation/filter vessel 106 in such a way as to cause as little agitation inside the separation vessel as possible. The separation/filter vessel 106 will begin to accumulate the solidified fats and waxes near the top as the oils and waxes separate from the CO₂ mixture due to low temperatures. A separation vessel inlet tube 126 on the inlet of separation/filter vessel 106 allows incoming CO₂/extract mixture from the cavitation mixing vessel 104 to pass through any oil layer in the separation/filter vessel 106 without excessive agitation. A filter element 130 at the bottom of the separation/filter vessel 106, optionally sintered and/or made from stainless steel, can prevent fats and waxes from exiting the vessel while allowing the remaining CO₂ mixture with desired compounds for collection (minus the fats and waxes) through. An evaporation vessel inlet tube 124 on the evaporation vessel 108 is preferably located at the same height as the separation vessel inlet. A high purity gas filter can also be integrated into the system assembly as a variety of locations as needed. In particular, a coalescing high purity gas filter can be used to scrub any leftover compounds and water vapor from the gas stream. Other optional components which can be integrated into the assembly can include one or more of a condensing heat exchanger, an air cooled process chiller to cool accumulator and/or condenser, an air compressor, and a hot water circulating system for the heat exchanger.

The system assembly can also optionally have an electronic control system having circuitry, hardware, and software for controlling and reporting one or more of: inputting batch parameters; separation tracking; monitoring and recording system parameters at defined intervals; printing batch records with associated pressures and temperatures; controlling separation parameters based on user input to adjust pressure, temperature, flow, or other process parameters; initiating cleaning cycles; detecting system failures; initiating emergency shutdown procedures; and connecting to one or more networks for monitoring and reporting. The electronic control system can comprise one or more microcontrollers connected wired or wirelessly to one or more sensors, the one or more sensors for detecting, for example, pressure, temperature, fluid flow, and other fluid properties such as colour, viscosity, turbidity, and other properties. The assembly can further comprise one or more shunts or valves which can direct small amounts of process fluid to sensor or analytical devices to test, monitor, and control aspects of the separation/extraction, optionally providing feedback information to the system to change one or more physical parameters of the process. In one example, the operation of the cavitation mixer in the separation/filter vessel 106 can be adjusted to increase or decrease speed or frequency to provide optimal cavitation for the material being processed. Other physical parameters that can be controlled using the control system include but are not limited to pressure, temperature, fluid flow rates. In addition, the separation system can further comprise one or more electric heaters, electric motor controls, emergency stop circuitry, or automatic closure of an accumulator tank, and automatic switching of process valves, all of which can be optionally monitored and controlled by the control system. An in situ measurement device can also be used for determining the completion and real time separation rate of the extracted material, in one example, of dissolved plant extracts and cannabinoids. The system or assembly itself can be integrated directly into a CO₂ extraction process, where the input material is the extraction collection material.

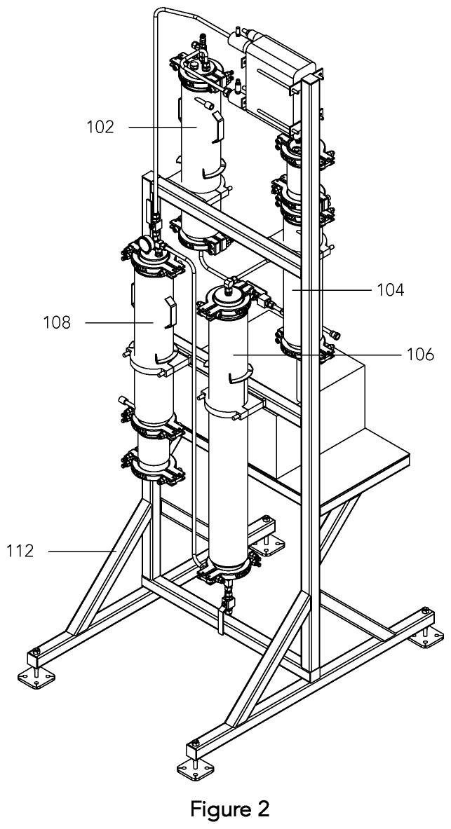

FIG. 2 is a perspective view of a cavitation separation and purification assembly showing fluid reservoir 102, an induced cavitation mixing vessel 104, a separation and filter vessel 106, evaporation vessel 108, and support structure 112.

FIG. 3A is phase diagram of carbon dioxide, which shows the phases of carbon dioxide at various temperatures and pressures, as well as the saturation line at which the CO₂ exists in liquid and vapor phase.

FIG. 3B is a graph of density as a function of temperature of isobaric carbon dioxide at 500 psi. By changing the solvent temperature in the present system materials of differering densities can be efficiently extracted.

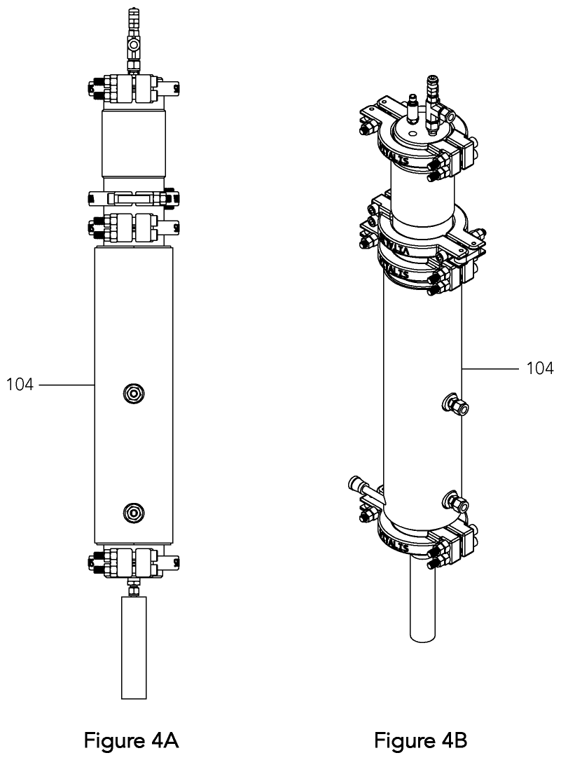

FIG. 4A is a side view of the outside housing of a cavitation mixing vessel 104. FIG. 4B is a perspective view of the outside housing of a cavitation mixing vessel 104. An induced cavitation mixer is mounted in a secure manner inside the cavitation mixing vessel 104 such that cavitation can occur inside the cavitation mixing vessel 104 while maintaining the structural integrity of the cavitation mixing vessel 104.

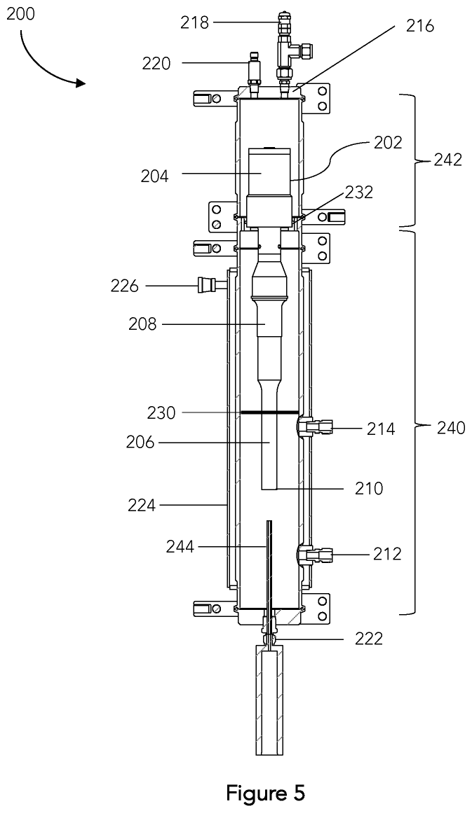

FIG. 5 is a cross-sectional view of a cavitation mixing vessel 200 comprising a cavitation mixer 202 mounted on its interior. The cavitation mixer 202 shown is a sonication-type cavitation mixer comprising a piezoelectric transducer 204. Piezoelectric transducers are a type of electroacoustic transducer that convert the electrical charges produced by some forms of solid materials into kinetic energy. The cavitation mixer 202 shown is an ultrasonic mixer, also commonly referred to as a sonicator, and is supported inside the cavitation mixing vessel 200 by a cavitation mixer mount 232 such that the cavitation mixer is surrounded by a combination of liquid and gaseous solvent. When in use with a subcritical fluid, solvent fluid below fluid interface 230 is liquid and above fluid interface 230 is gaseous and equalized around the top of the cavitation mixing vessel 200 by movement of fluid solvent through apertures or channels in the cavitation mixer mount 232 which fluidly connects the lower chamber 240 below the cavitation mixer mount 232 with the upper chamber 242 above the cavitation mixer mount 232. Without being bound by theory, it is believed that pressure equalization above and below the cavitation mixer mount 232 inside the cavitation mixing vessel 200 counteracts the differential force created by the cavitation mixer and stabilizes the cavitation mixer inside the cavitation mixing vessel.

Cavitation mixer 202 shown comprises a piezoelectric transducer 204 connected to an electrical power source to generate an ultrasonic vibration, which is transferred to an optional sonotrode booster 208 connected to sonication horn 206 with horn end 210. Piezoelectric transducer 204 is joined to the horn 210 optionally through a vibration transmitting block or sonotrode booster 208, which is used to amplify the vibration amplitude generated by the transducer 204, as the vibration amplitude of the transducer itself is sometimes not sufficient for mixing in many industrial processes. The optional sonotrode booster 208 can thereby provide an acoustic gain to the ultrasonic vibrations. The sonication horn 206 can have a variety of shapes and sizes, and can be conical, straight, or barbell shaped as desired. The horn end 210 configuration can be variable in size, cross-sectional shape, and surface area and can be pointed, flat, rounded, and have a variety of cross-sectional areas and shapes. The booster, horn, or both can also clad or plated with a reflective material that reflects ultrasonic vibrations or lessens loss of ultrasonic energy being transmitted to the horn.

The cavitation mixing vessel 200 accepts a metered amount of raw plant oils and waxes, also referred to as crude oil, through material inlet 222 with optional extended injection tube 244 and uses a cavitation mixer attachment to combine the extract with incoming clean CO₂ fed through solvent inlet 212 from the CO₂ reservoir. Homogeneous discharge outlet 214 just below the fluid interface 230 directs CO₂ solvent mixed with cavitation-treated and solubilized or emulsified oils and waxes out of the cavitation mixing vessel 200. The cavitation mixing vessel 200 is cooled through a refrigerated jacket and cooling jacket 224 with cooling jacket port 226 to maintain the liquid phase of CO₂ inside the vessel and to extract the heat input from the cavitation mixing vessel 200. The raw oil in the plant extract benefits from thorough mixing provided by cavitation to separate the fats and waxes from the desired compounds. The mixing time and amount in a continuous feed process can be controlled by the injection rate of the raw extract into the cavitation mixing vessel 200 and the injection rate of clean solvent through solvent inlet 212. The end surface of the induced cavitation device or cavitation mixer 202 is preferably positioned in a location within the effective zone of cavitation below the fluid interface 230 as initiated by the mixing device relative to the injection tube 244 such that crude oil is directed in the immediate vicinity of the horn end 210 of cavitation mixer 202. The liquid flow path inside the vessel is such that the entering liquid and crude oil strikes the end of the horn at a direction normal to the horn end 210, then flows across the surface of the horn before leaving the cavitation mixing vessel 200. The cavitation mixing vessel 200 has a high pressure electrical pass through fitting 216 for supplying power to the induced cavitation mixer 202, and adjacent pressure safety valve 218 and pressure sensor 220. The ultrasonic energy generated by the sonotrode can have a frequency in the range of, for example, 20 KHz to 1.0 MHz, or preferably from 20 KHz to 70 KHz. The frequency of the current is chosen to be the resonant frequency of the tool, so the entire sonotrode acts as a half-wavelength resonator, vibrating lengthwise with standing waves at its resonant frequency. The amplitude of sonotrode vibration is generally small, ranging from about 13 to 130 micrometres.

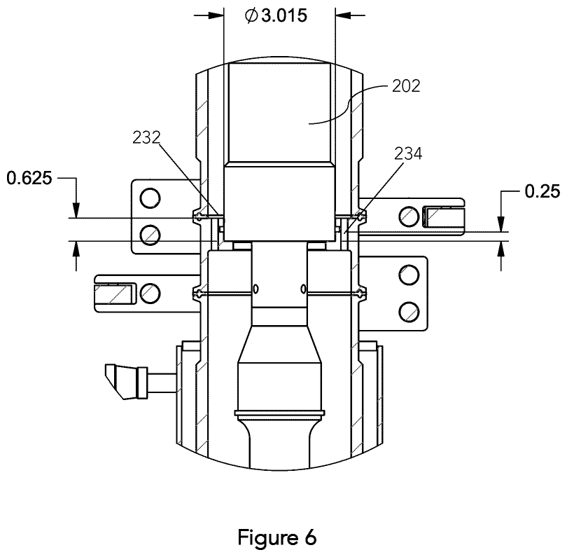

FIG. 6 is close-up cross sectional view of the top part of a cavitation mixer 202 inside a cavitation mixing vessel. Cavitation mixer mount 232 comprises a plurality of fluid channels 234 to allow gaseous CO₂ to flow through the fluid channels 234 and above the cavitation mixer. Although the fluid channels shown are apertures or bore holes in the cavitation mixer mount 232, it is understood that other configurations of the mixer mount which is capable of providing or enabling fluid flow above and below the mixer mount are possible, including but not limited to steel structures with arm supports, and supported mesh materials. Cavitation mixer mount 232 holds the cavitation mixer in place during cavitation and mixing. An annular groove adjacent the cavitation mixer mount 232 can be fitted with a gasket or O-ring to further stabilize the cavitation mixer inside the cavitation mixing vessel. Exemplary measurements are provided solely for the purpose of showing relative scale of one example embodiment however the present mixer mount, cavitation mixer, and cavitation mixing vessel can be of any reasonable size.

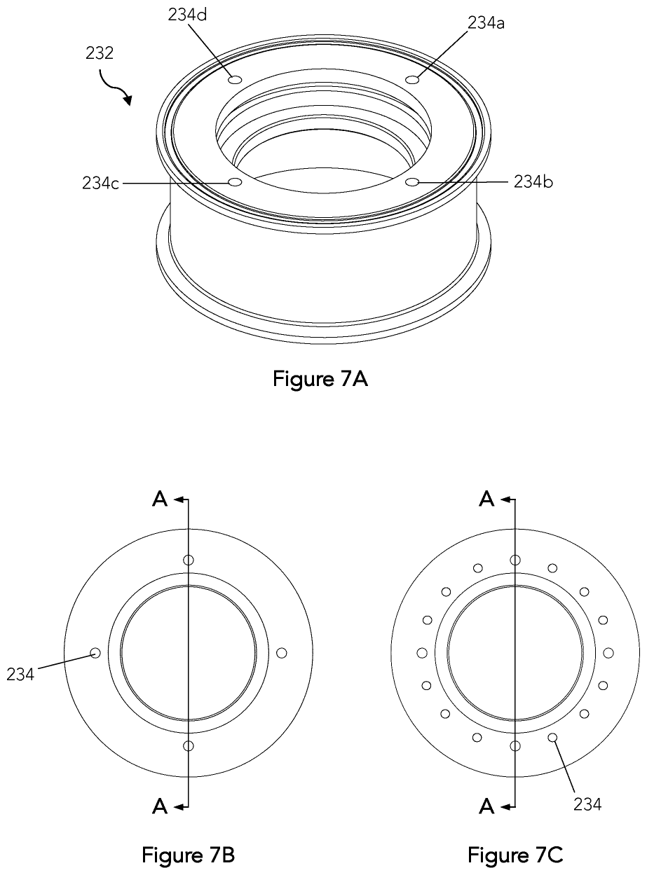

FIG. 7A is a top perspective view of a cavitation mixer mount 232 with four fluid channels 234a, 234b, 234c, and 234d. Fluid channels 234a, 234b, 234c, and 234d extend all the way through cavitation mixer mount 232 to provide means and channels for fluid flow above and below cavitation mixer mount 232 in the cavitation mixing vessel. Any number of fluid channels can be provided to enable gaseous carbon dioxide to flow above the cavitation mixer mount. FIG. 7B is a top view of an embodiment cavitation mixer mount with four fluid channels 234, only one of which is labeled. FIG. 7C is a top view of another embodiment of a cavitation mixer mount having sixteen fluid channels 234, only one of which is labeled.

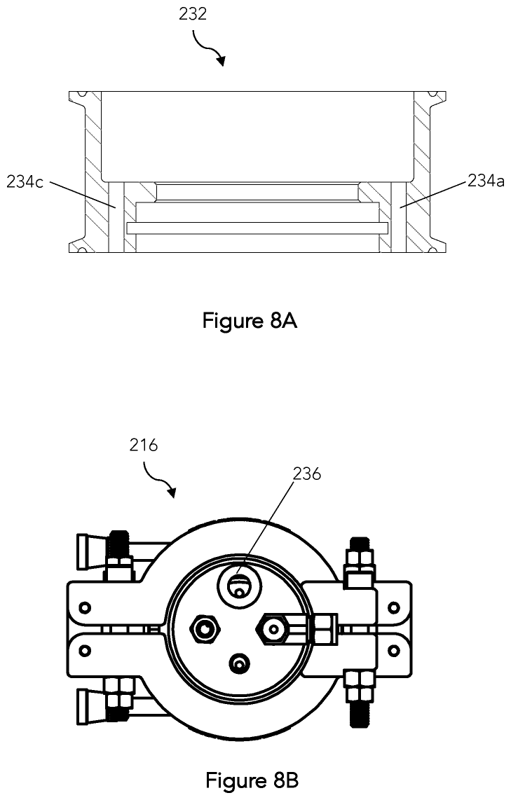

FIG. 8A is a side cross-sectional view of a cavitation mixer mount through plane A-A as shown in FIG. 7B or FIG. 7C. A cross section of fluid channels 234a and 234c is shown to demonstrate how gaseous CO₂ is capable of moving through the fluid channels and equalizing on either side of the cavitation mixer mount, above and below the cavitation mixer, when mounted inside a cavitation mixing vessel.

FIG. 8B is a top view of a high pressure electrical pass through fitting 216 for a cavitation mixing vessel. The electrical pass through fitting 216 accommodates the power supply for the embedded cavitation mixer inside the cavitation mixing vessel and is capable of withstanding the low temperatures and high pressures required to support solvent processes inside the cavitation mixing vessel. Electrical connection 236 is connected to a power supply to power the cavitation mixer.

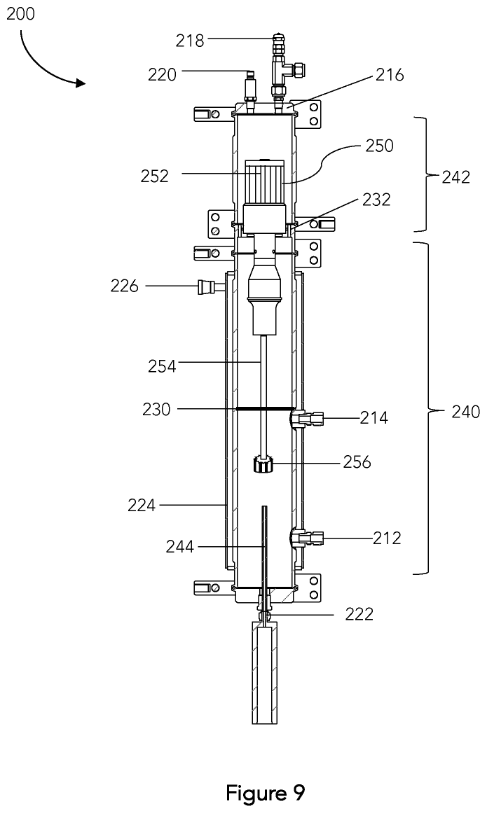

FIG. 9 is cross-sectional view of a cavitation mixing vessel 200 with a high shear cavitation mixer 250. High shear cavitation mixer 250 comprises motor 252, shaft 254, and rotor 256. The cavitation mixing vessel 200 with high shear cavitation mixer 250 operates in a similar way as one fitted with a sonicator to generate cavitation bubbles in the solvent, only as a result of applying rotational shear instead of through ultrasonic wave application to the solvent. Other features of the cavitation mixing vessel 200 are common to those where the cavitation mixer is a sonicator. These common features include the solvent inlet 212 and homogeneous discharge outlet 214, material inlet 222 and injection tube 244, cavitation mixer mount 232, fluid interface 230, and cavitation vessel lower chamber 240 and cavitation vessel upper chamber 242. Other common features include a high pressure electrical pass through fitting 216, pressure safety valve 218, pressure sensor 220, and cooling jacket 224 with cooling jacket port 226. Preferably the high shear cavitation mixer is operable from 0-10,000 rpm.

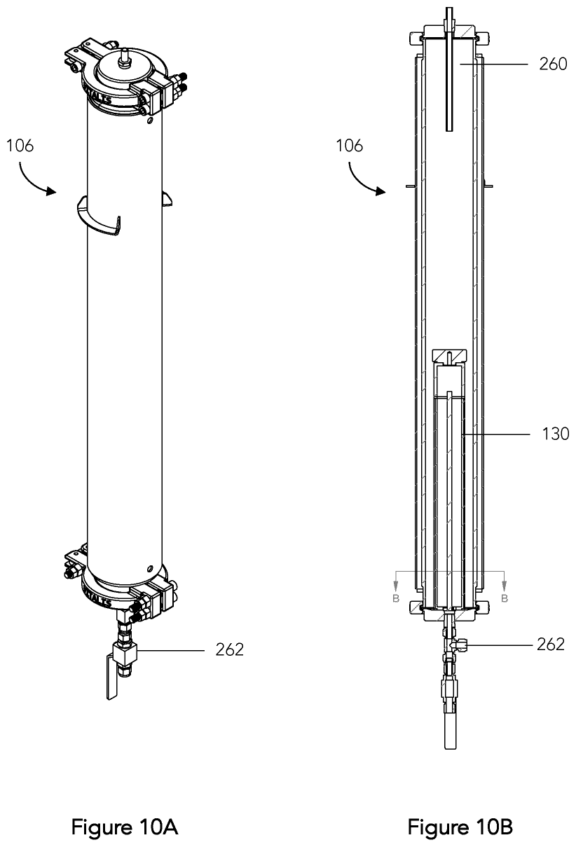

FIG. 10A is a front perspective view of a separation/filtration vessel 106, and FIG. 10B is a longitudinal cross-sectional view of a separation/filtration vessel 106. The separation/filtration vessel comprises a filter apparatus or filter element 130 for filtering out dissolved material from emulsified or solid material. The filter can have pores of a variety of sizes, preferably from 0.5 micron to 500 micron. The filter can further be made of any suitable material which excludes waxes but allows smaller particulate be filtered, such as, for example, a mesh material such as a metal mesh, or a porous material. Separation vessel has a wax collection area 260 at the top of the vessel and a separation vessel valve 262 which is optionally a fill ball valve.

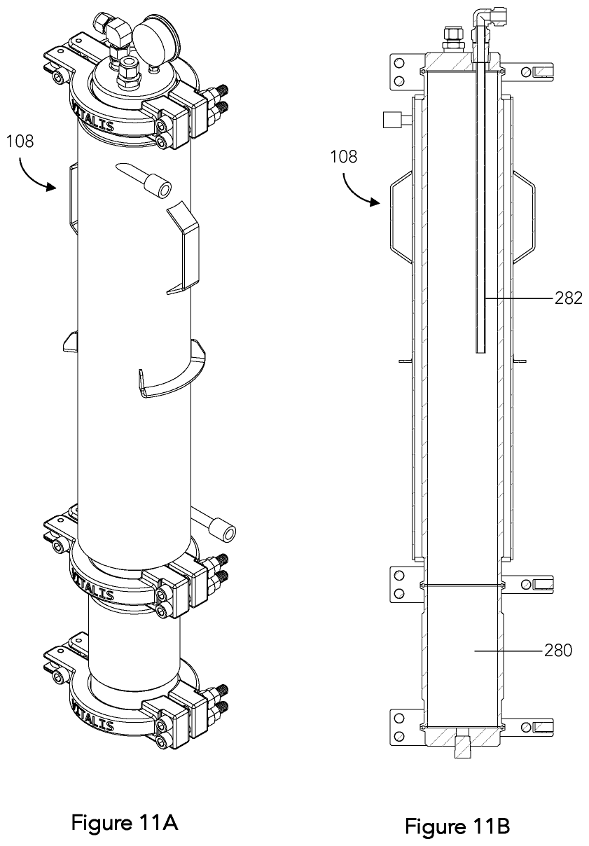

FIG. 11A is a perspective view of an evaporation vessel 108 and FIG. 11B is a cross-sectional view through an evaporation vessel 108. The evaporation vessel 108 preferably comprises a thermally controlled jacket to facilitate the evaporation of the CO₂ and the collection of the desirable solutes carried with the solvent. The thermally controlled jacket is of a higher temperature than the solvent, however may need to be cooled for control of boiling temperature of the solvent. The dewaxed solution enters evaporation vessel through the top cap and evaporation vessel inlet tube 282, and the CO₂ is boiled at the bottom of vessel and vapour exits through an adjacent port in the top cap. The solutes the CO₂ was carrying will not evaporate and will instead fall to the bottom of the vessel which has a removeable collection pot 280. The evaporation column or evaporation vessel is preferably jacketed and temperature is regulated with a thermal control fluid, such as, for example, propylene glycol. By changing the separation pressure and temperature of subcritical CO₂, solubility and selectivity for a species of interest can be changed to optimize the separation. CO₂ displays exceptional extractant selectability over a wide range of pressures, from 80 to 15,000 psi. After fractioning, the product of interest is isolated from the CO₂ by evaporation of the solvent. In one method, following a subcritical separation with a supercritical extraction to completely scrub the solid matrix extractant of any remaining valuable compounds can achieve a full-spectrum and highly effective separation.

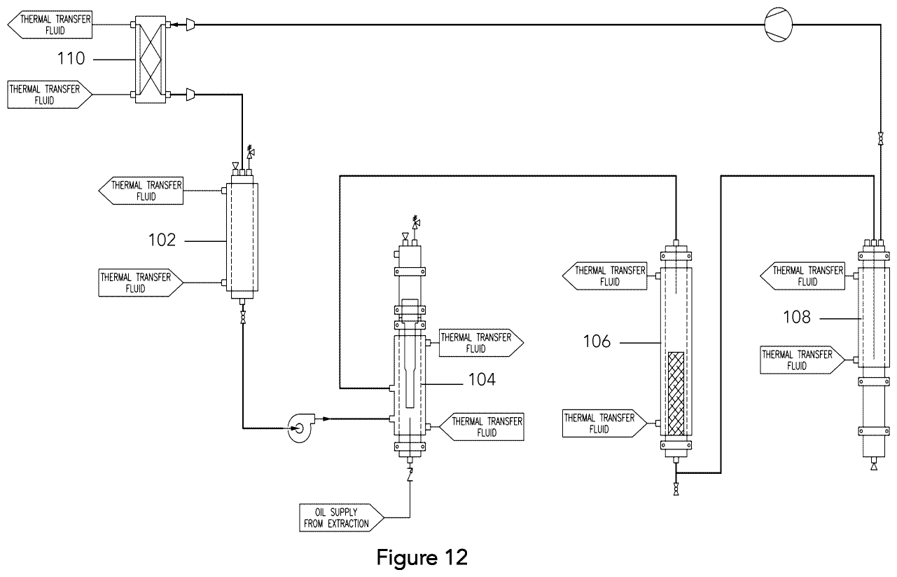

FIG. 12 is a system diagram of a cavitation dewaxing assembly. The system comprises, in series, fluid reservoir 102, cavitation mixing vessel 104, separation/filter vessel 106, evaporation/collection vessel 108, and condenser 110. For efficiency, to reduce waste and limit production costs, it is also of benefit for the facility to collect and recycle the CO₂ used as the solvent.

All publications, patents and patent applications mentioned in this specification are indicative of the level of skill of those skilled in the art to which this invention pertains and are herein incorporated by reference. The invention being thus described, it will be obvious that the same may be varied in many ways. Such variations are not to be regarded as a departure from the scope of the invention, and all such modifications as would be obvious to one skilled in the art are intended to be included within the scope of the following claims.

1. A cavitation mixing apparatus comprising:
a cavitation mixing vessel comprising a material inlet and a discharge outlet, the cavitation mixing vessel capable of containing pressurized liquid CO₂;
a cavitation inducing device mounted inside the cavitation mixing vessel;
an electrical connection for connecting the cavitation inducing device to a power supply through the cavitation mixing vessel; and
a cavitation mixer mount for mounting the cavitation inducing device inside the cavitation mixing vessel, the cavitation mixer mount comprising at least one fluid channel for equalizing pressure of CO₂ around the cavitation mixer inside the cavitation mixing vessel.

2. The mixing apparatus of claim 1, wherein the cavitation inducing device is an ultrasonic mixer.

3. The mixing apparatus of claim 2, wherein the ultrasonic mixer produces an ultrasonic vibration at a frequency of at least 20 KHz.

4. The mixing apparatus of claim 2, wherein the ultrasonic mixer operates at a frequency of between 20 KHz to 1.0 MHz.

5. The mixing apparatus of claim 1, wherein the cavitation inducing device is a high shear cavitation mixer.

6. The mixing apparatus of claim 1, further comprising an injection tube to direct crude oil proximate the cavitation inducing device.

7. The mixing apparatus of claim 1, wherein the cavitation mixer mount comprises a plurality of fluid channels.

8. A cavitation dewaxing system comprising:
a carbon dioxide reservoir for containing liquid carbon dioxide;
a cavitation mixing vessel comprising an encapsulated cavitation inducing device;
a separation vessel; and
an evaporation vessel.

9. The system of claim 8, wherein the cavitation inducing device is an ultrasonic mixer.

10. The system of claim 8, wherein the cavitation inducing device is a high shear cavitation mixer.

11. The system of claim 8, further comprising a carbon dioxide condenser.

12. The system of claim 8, wherein the separation vessel comprises a filter.

13. The system of claim 8, which is a passive circulation system.

14. A method of separating oils from a crude plant oil mixture, the method comprising:
injecting crude plant oil into a pressurized mixing vessel comprising liquid carbon dioxide; and
mixing the crude oil with the liquid carbon dioxide under pressure using powered induced cavitation, the cavitation mixing vessel comprising an encapsulated cavitation inducing device.

15. The method of claim 14, where the induced cavitation is provided by an ultrasonic mixer.

16. The method of claim 14, where the induced cavitation is provided by a high shear mixer.

17. The method of claim 14, wherein the pressure of liquid carbon dioxide in the mixing vessel is 80 to 15,000 psi.

18. The method of claim 14, wherein the method is in a batch, semi-continuous, or continuous industrial process.

19. The method of claim 14, further comprising filtering the crude oil and liquid carbon dioxide mixture, and evaporating off the carbon dioxide to isolate a purified plant oil.
